(19) United States
(12) Patent Application Publication
(10) Pub. No.: US 2023/0177598 A1
(43) Pub. Date: Jun. 8, 2023

(54) VEHICLE MANAGEMENT SYSTEM, VEHICLE MANAGEMENT METHOD, AND STORAGE MEDIUM

(71) Applicant: HONDA MOTOR CO., LTD., Tokyo (JP)

(72) Inventor: Kenichi KOBAYASHI, Tokyo (JP)

(21) Appl. No.: 17/970,643

(22) Filed: Oct. 21, 2022

(30) Foreign Application Priority Data
Dec. 6, 2021 (JP) 2021-197839

(51) Int. Cl. G06Q 30/06

(52) U.S. Cl. CPC G06Q 30/0645

(57) ABSTRACT

A storage unit stores user information for identifying a plurality of users that are employees of a corporation, and vehicle information including a lending status of a plurality of vehicles that travel by electric power. An identification unit identifies a first user on a basis of the user information. A first receiving unit receives a renting request from the first user. A lending unit executes lending processing of lending a first vehicle among the plurality of vehicles to the first user in accordance with the reception of the renting request. The lending processing includes processing of selecting, from the plurality of vehicles, the first vehicle that is not selected before the reception of the renting request on a basis of the lending status, and processing of updating the lending status so as to reflect the lending of the first vehicle.

### CROSS REFERENCE TO RELATED APPLICATION(S)

This application claims priority to and the benefit of Japanese Patent Application No. 2021-197839 filed on Dec. 6, 2021, the entire disclosure of which is incorporated herein by reference.

### BACKGROUND OF THE INVENTION

### Field of the Invention

The present invention relates to a vehicle management system, a vehicle management method, and a storage medium.

### Description of the Related Art

Japanese Patent Laid-Open No. 2019-153114 discloses a technique of utilizing an electric vehicle (EV) or the like parked in a parking lot in order to realize optimization of peak cut and peak shift in a wide area without newly introducing large-scale equipment of a secondary battery.

The EV disclosed in Japanese Patent Laid-Open No. 2019-153114 includes an EV for a vehicle sharing service (such as a car sharing business), but Japanese Patent Laid-Open No. 2019 -153114 does not consider that a corporation allows employees to share the EV

### SUMMARY OF THE INVENTION

The present invention has been made in view of such a situation, and provides a technique for promoting efficient shared use of vehicles that travels by electric power among corporate employees.

According to an aspect of the present invention, there is provided a vehicle management system comprising at least one processor and/or at least one circuit which functions as: a storage unit configured to store user information for identifying a plurality of users that are employees of a corporation, and vehicle information including a lending status of a plurality of vehicles that travel by electric power; an identification unit configured to identify a first user included in the plurality of users on a basis of the user information; a first receiving unit configured to receive a renting request from the first user; and a lending unit configured to execute lending processing of lending a first vehicle among the plurality of vehicles to the first user in accordance with the reception of the renting request, wherein the lending processing includes: processing of selecting, from the plurality of vehicles, the first vehicle that is not selected before the reception of the renting request on a basis of the lending status; and processing of updating the lending status so as to reflect the lending of the first vehicle.

### BRIEF DESCRIPTION OF THE DRAWINGS

FIG. 1 is a diagram illustrating a configuration of a vehicle management system 100;

FIG. 2 is a conceptual diagram of a parking lot 200;

FIG. 3 is a functional block diagram of a vehicle 300;

FIG. 4 is a functional block diagram of a power control apparatus 400;

FIG. 5 is a functional block diagram of a vehicle management apparatus 500;

FIG. 6 is a functional block diagram of a user terminal 600;

FIG. 7 is a diagram illustrating a configuration of a user DB 700;

FIG. 8 is a diagram illustrating a configuration of a vehicle DB 800;

FIG. 9 is a diagram illustrating a configuration of a reservation DB 900;

FIG. 10 is a diagram illustrating an example of a screen of a vehicle application installed in the user terminal 600;

FIG. 11 is a diagram illustrating an example of a screen of the vehicle application installed in the user terminal 600;

FIG. 12 is a flowchart of processing executed by the vehicle management apparatus 500;

FIG. 13 is a flowchart illustrating details of login processing (S1202 of FIG. 12);

FIG. 14 is a flowchart illustrating details of lending processing (S1204 of FIG. 12);

FIG. 15 is a flowchart illustrating details of returning processing (S1206 of FIG. 12); and

FIG. 16 is a flowchart illustrating details of reservation processing (S1208 of FIG. 12).

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

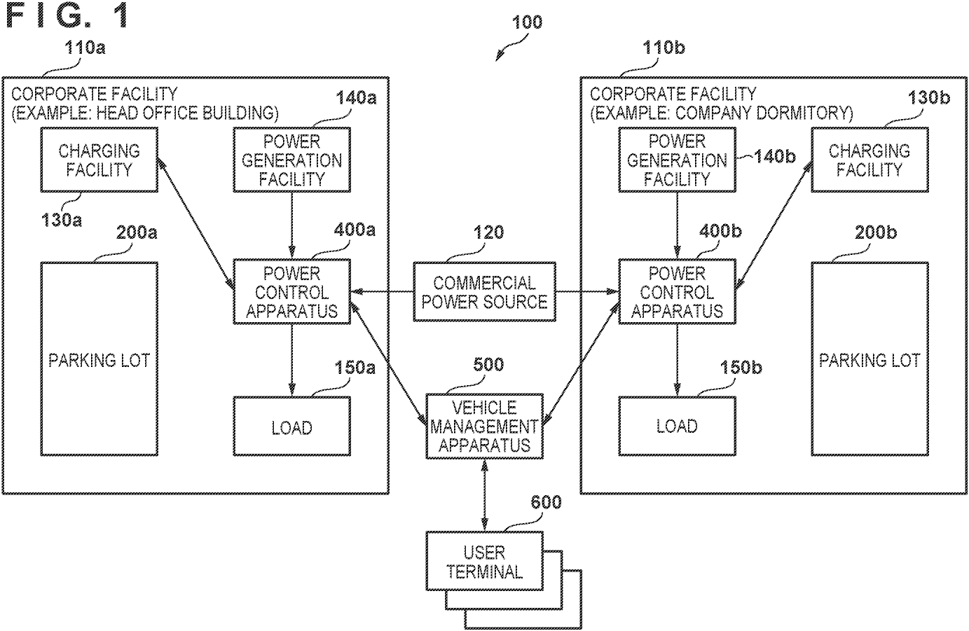

FIG. 1 is a diagram illustrating a configuration of a vehicle management system 100. The vehicle management system 100 includes at least one corporate facility (a corporate facility 110a and a corporate facility 110b in the example of FIG. 1), a commercial power source 120, a plurality of vehicles 300 (not illustrated in FIG. 1), a vehicle management apparatus 500, and a plurality of user terminals 600.

In the case where it is not necessary to strictly distinguish the corporate facilities in the description of the embodiments, the corporate facilities included in the vehicle management system 100 are simply referred to as corporate facilities 110. The same applies to components included in each corporate facility, and for example, in the case where it is not necessary to strictly distinguish a charging facility 130a included in the corporate facility 110a and a charging facility 130b included in the corporate facility 110b in describing the embodiment, a notation of a charging facility 130 is used.

The corporate facility 110 is a facility under the control of a corporation (for example, a company). The corporate facility 110 includes the charging facility 130, a power generation facility 140, a load 150, a parking lot 200, and a power control apparatus 400. In the following description, it is assumed that the corporate facility 110a is a head office building and the corporate facility 110b is a company dormitory.

The charging facility 130 includes a plurality of chargers for charging a plurality of vehicles 300 parked in the parking lot 200. The charging facility 130 charges the vehicles 300 by using power received from the power control apparatus 400 under the control of a vehicle management apparatus 500. The charging facility 130 can also receive power from a vehicle 300 connected to the charger and supply the power to the power control apparatus 400 under the control of the vehicle management apparatus 500. The power generation facility 140 is a facility for private power generation, and includes, for example, a solar panel. The load 150 collectively represents various apparatuses that consume power in the corporate facility 110, and includes personal computers (PC), air conditioners, electric lights, and the like.

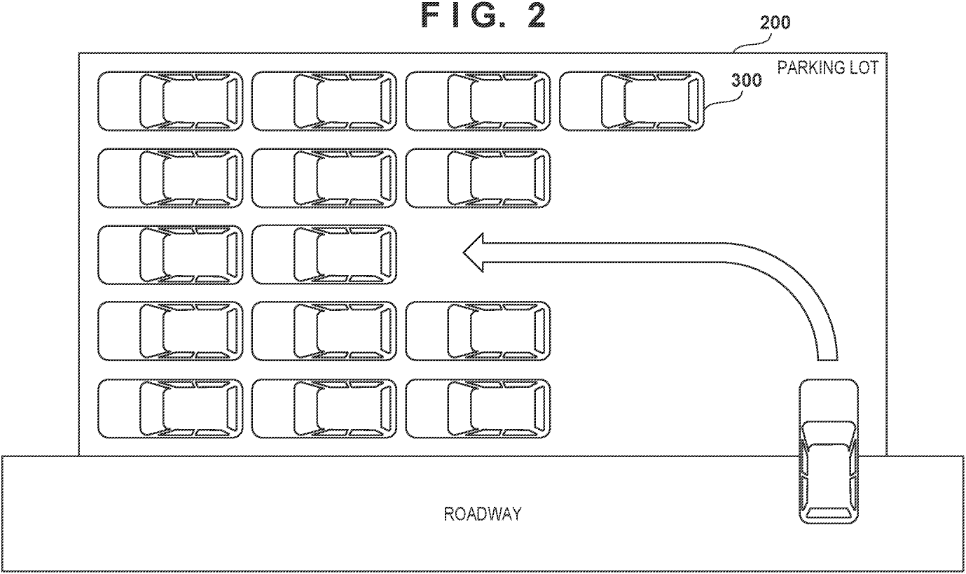

FIG. 2 is a conceptual diagram of the parking lot 200. In the parking lot 200, some of the plurality of vehicles 300 included in the vehicle management system 100 are highly densely parked. By adopting, as the parking lot 200, a parking lot in which parking of at least a part of the plurality of vehicles 300 at a high density is possible, it is possible to reduce the number of vehicle paths in the parking lot 200, and the utilization efficiency of the site of the corporate facility 110 is improved. Note that the term “high density” as used herein means a densely packed state in which at least one parked vehicle 300 cannot be moved unless at least one other parked vehicle is moved.

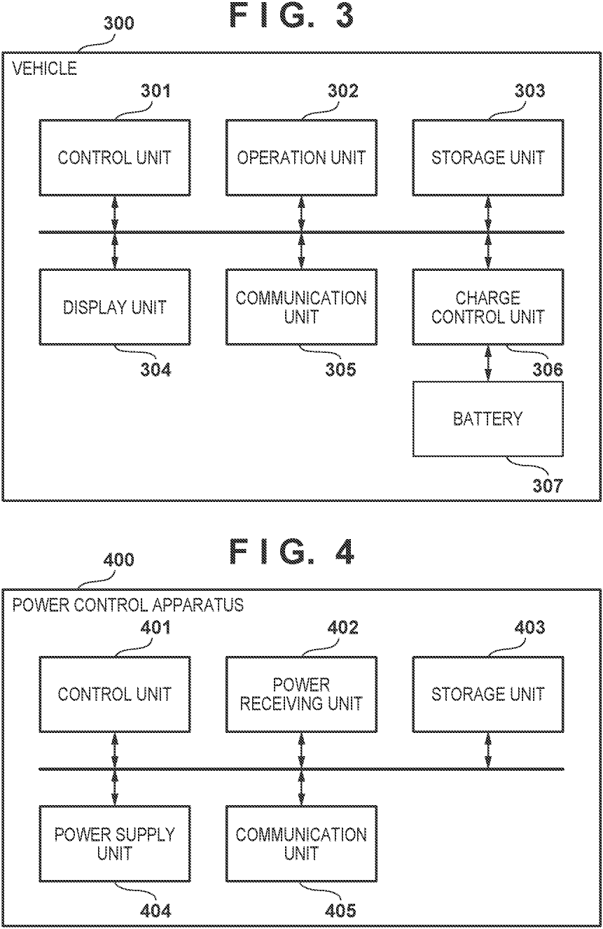

FIG. 3 is a functional block diagram of the vehicle 300. The vehicle 300 is a vehicle that travels by electric power, and is, for example, an electric vehicle (EV). A control unit 301 includes, for example, a central processing unit (CPU), a read-only memory (ROM), a random access memory (RAM), and the like, and controls the entire vehicle 300 by executing various programs. An operation unit 302 includes, for example, an input device such as a button and a touch panel, and receives an input operation by a user. A storage unit 303 includes a recording medium such as a hard disk drive (HDD) or a solid state drive (SSD), and stores various programs. A display unit 304 includes, for example, a liquid crystal display, and displays a user interface, various types of information, and the like. A communication unit 305 is a communication unit for the vehicle 300 to communicate with an external apparatus (such as the vehicle management apparatus 500) via a communication network. A charge control unit 306 charges the battery 307 by using the power supplied from the charging facility 130. In addition, the charge control unit 306 can also supply power stored in a battery 307 to the charging facility 130.

FIG. 4 is a functional block diagram of the power control apparatus 400. The power control apparatus 400 is implemented by, for example, a computer connectable to a communication network. A control unit 401 includes, for example, a CPU, a ROM, a RAM, and the like, and controls the entire power control apparatus 400 by executing various programs. In addition, the control unit 401 predicts future power demand in the corporate facility 110 and notifies the vehicle management apparatus 500 of the predicted power demand. In addition, the control unit 401 predicts a future power generation amount of the power generation facility 140 and notifies the vehicle management apparatus 500 of the predicted power generation amount. A power receiving unit 402 receives power from the commercial power source 120 and the power generation facility 140. In addition, the power receiving unit 402 can also receive the power stored in the battery of the vehicle 300 connected to the charger from the charging facility 130. A storage unit 403 includes a recording medium such as an HDD or an SSD, and stores various programs. A power supply unit 404 supplies the power received by the power receiving unit 402 to the charging facility 130 and the load 150. A communication unit 405 is a communication unit for the power control apparatus 400 to communicate with an external apparatus (such as the vehicle management apparatus 500) via a communication network.

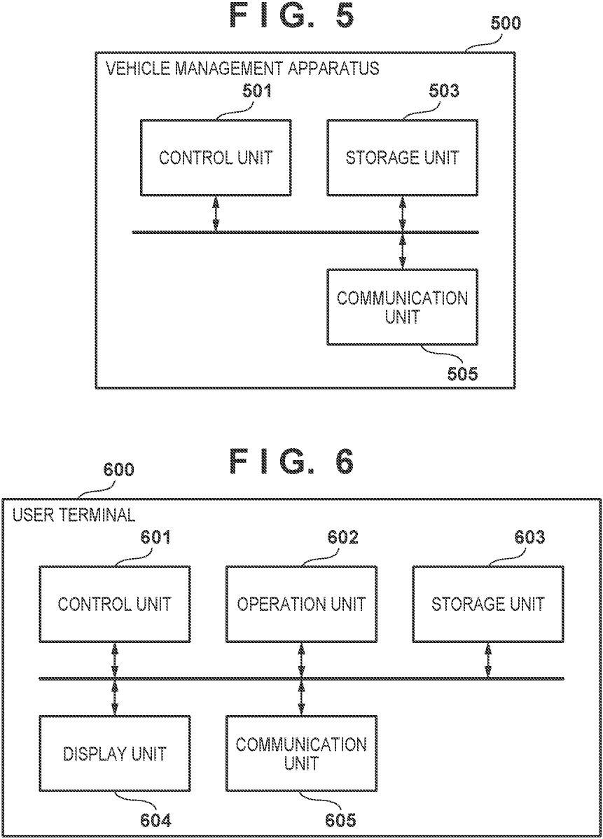

FIG. 5 is a functional block diagram of the vehicle management apparatus 500. The vehicle management apparatus 500 is implemented by, for example, a computer connectable to a communication network. A control unit 501 includes, for example, a CPU, a ROM, a RAM, and the like, and controls the entire vehicle management apparatus 500 by executing various programs. A storage unit 503 includes a recording medium such as an HDD or an SSD, and stores various programs. Furthermore, the storage unit 503 also stores a user DB 700, a vehicle DB 800, and a reservation DB 900 to be described later. A communication unit 505 is a communication unit for the vehicle management apparatus 500 to communicate with an external apparatus (such as the vehicle 300, the power control apparatus 400, and the user terminal 600) via a communication network.

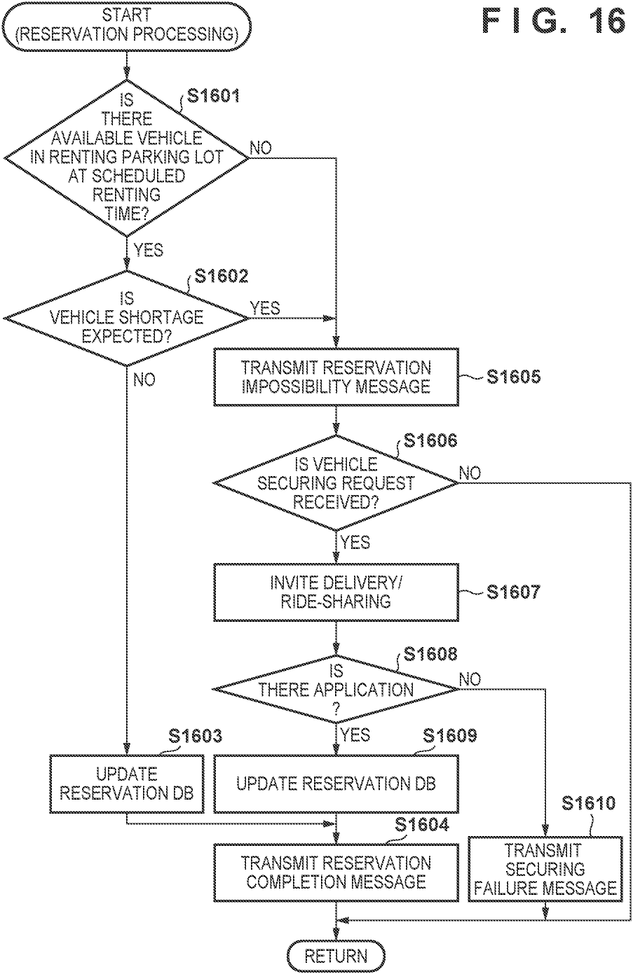

The control unit 501 of the vehicle management apparatus 500 can plan the delivery of vehicles from the outside to the inside of the corporate facility 110 on the basis of the prediction of the power demand in the corporate facility 110 acquired from the power control apparatus 400. For example, when focusing on the corporate facility 110a, the control unit 501 plans delivery of a vehicle from a parking lot 200b outside the corporate facility 110a to a parking lot 200a inside the corporate facility 110a when the predicted power demand is large. When the vehicles are delivered according to the plan, the number of vehicles 300 connected to the chargers of the charging facility 130a can be increased. Then, the control unit 501 controls the power charged in the vehicle 300 (strictly, the battery 307) connected to the charger of the charging facility 130a to be supplied to a load 150a, thereby increasing the amount of power usable in the corporate facility 110a. A method of performing the planned delivery of the vehicle is not particularly limited, but for example, the delivery of the vehicle can be performed by recruiting users who deliver the vehicle as described with reference to steps S1607 and S1608 in FIG. 16.

FIG. 6 is a functional block diagram of the user terminal 600. The user terminal 600 is, for example, a smartphone, but may be another type of device (for example, a tablet or the like). A control unit 601 includes, for example, a CPU, a ROM, a RAM, and the like, and controls the entire user terminal 600 by executing various programs. An operation unit 602 includes, for example, an input device such as a button and a touch panel, and receives an input operation by a user. A storage unit 603 includes a recording medium such as an HDD or an SSD, and stores various programs. A display unit 604 includes, for example, a liquid crystal display, and displays a user interface, various types of information, and the like. The communication unit 605 is a communication unit for the user terminal 600 to communicate with an external apparatus (such as the vehicle management apparatus 500) via a communication network.

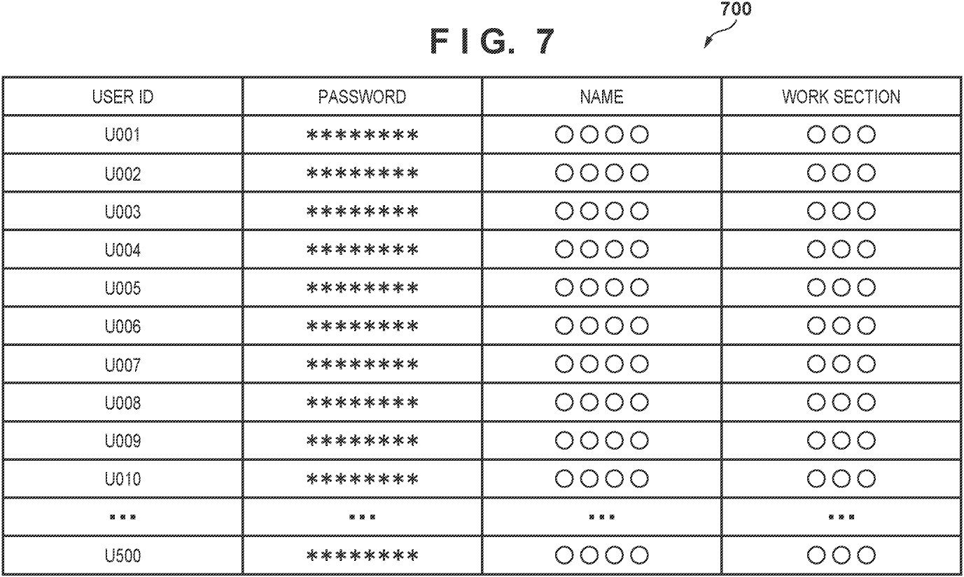

Next, the user DB 700, the vehicle DB 800, and the reservation DB 900 stored in the storage unit 503 of the vehicle management apparatus 500 will be described with reference to FIGS. 7 to 9.

FIG. 7 is a diagram illustrating a configuration of the user DB 700 stored in the storage unit 503 of the vehicle management apparatus 500. The user DB 700 is a database (DB) for managing user information for identifying a plurality of users who are corporate employees (a plurality of users who can rent the vehicle 300). The user DB 700 includes “user ID” and “password” as identification information and authentication information of each user. Furthermore, the user DB 700 may include “name”, “work section”, and the like of each user in addition to the identification information and the authentication information.

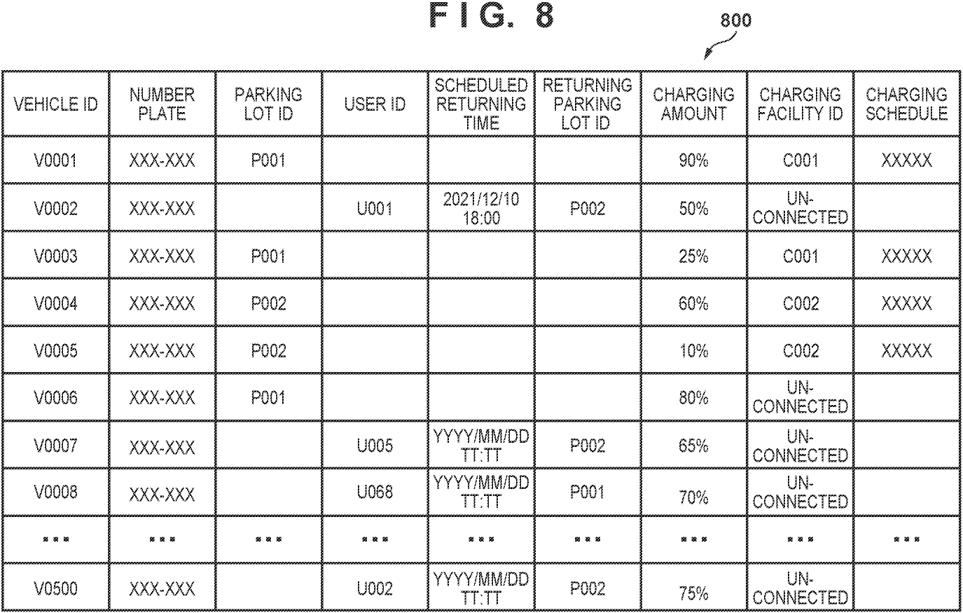

FIG. 8 is a diagram illustrating a configuration of the vehicle DB 800 stored in the storage unit 503 of the vehicle management apparatus 500. The vehicle DB 800 is a database (DB) for managing the vehicle 300. The vehicle DB 800 includes a “vehicle ID” for identifying the vehicle 300, a “license plate” indicating information of the license plate of the vehicle 300, and a “parking lot ID” for identifying the parking lot 200 in which the vehicle 300 is parked. Regarding the parking lot ID, in the following description, “P001” corresponds to the parking lot 200a of the corporate facility 110a, and “P002” corresponds to the parking lot 200b of the corporate facility 110b. In addition, for the vehicle 300 that is being lent, the “parking lot ID” is blank. In addition, the vehicle DB 800 includes a “user ID” of a user who is renting the vehicle 300. For the vehicle 300 that is not lent, the “user ID” is blank. Therefore, the vehicle management apparatus 500 can check the lending status of the plurality of vehicles 300 by referring to the vehicle DB 800.

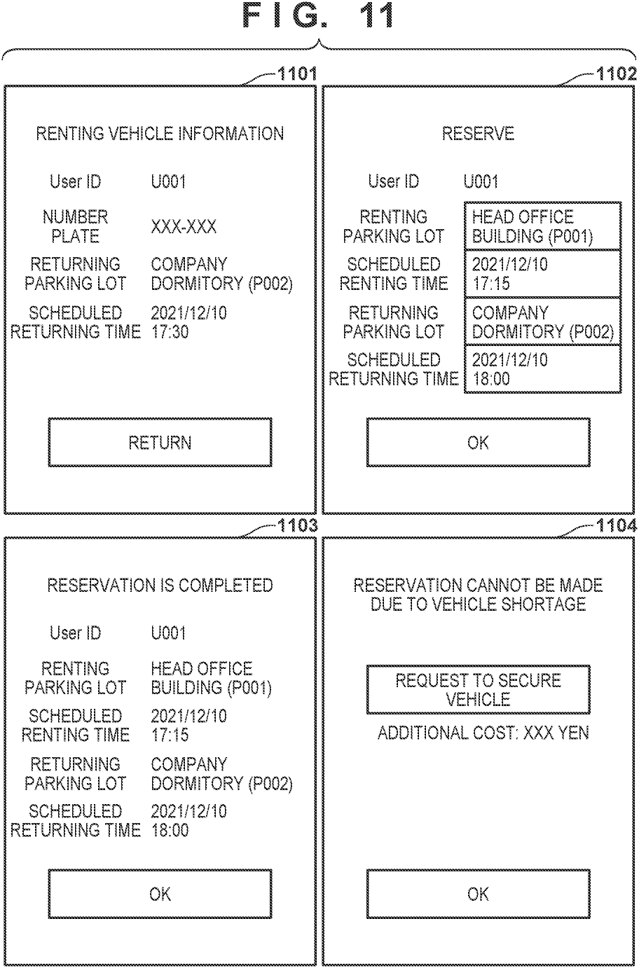

In addition, the vehicle DB 800 includes “scheduled returning time” and “returning parking lot ID” related to the vehicle 300 being lent. In the returning parking lot ID, a parking lot ID of a parking lot scheduled by the user as a return place of the vehicle 300 is registered. For example, an entry of “vehicle ID” = “V0002” in the vehicle DB 800 corresponds to a case where the vehicle is lent in accordance with information selected on a screen 1003 of FIG. 10 to be described later.

In addition, the vehicle DB 800 includes a “charging amount” of the battery 307 of the vehicle 300 and a “charging facility ID” for identifying the charging facility 130 corresponding to the charger to which the vehicle 300 is connected. Regarding the charging facility ID, in the following description, “C001” corresponds to the charging facility 130a, and “C002” corresponds to the charging facility 130b. In addition, “Unconnected” indicates that the vehicle 300 is not connected to the charger.

In addition, the vehicle DB 800 includes a “charging schedule” of the vehicle connected to the charger of the charging facility 130. The control unit 501 of the vehicle management apparatus 500 determines a charging schedule in accordance with a predetermined standard, and registers the determined charging schedule in the vehicle DB 800. Then, the control unit 501 of the vehicle management apparatus 500 controls the charging facility 130 via the power control apparatus 400 to charge the vehicle 300 in accordance with the charging schedule registered in the vehicle DB 800.

As an example of the standard for determining the charging schedule, the control unit 501 can determine the charging schedule on the basis of the prediction of the power demand in the corporate facility 110 acquired from the power control apparatus 400. In this case, for example, the control unit 501 determines the charging schedule so as to start charging at a timing when the predicted power demand is small. As another example, in the vehicle DB 800, the control unit 501 can determine the charging schedule on the basis of the prediction of the power generation amount of the power generation facility 140 acquired from the power control apparatus 400 in addition to the prediction of the power demand. In this case, for example, the control unit 501 determines the charging schedule so as to start charging at a timing when the predicted power demand is small and the predicted power generation amount is large.

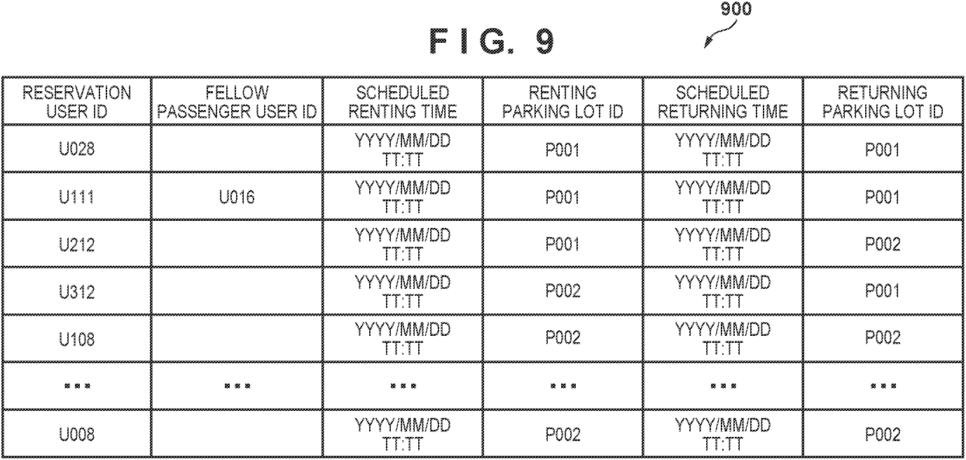

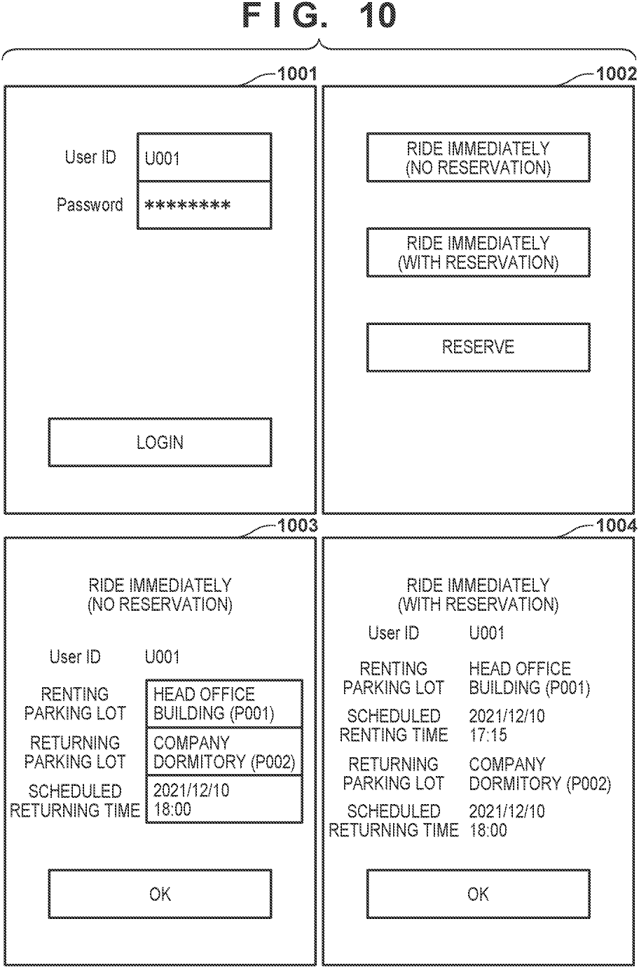

FIG. 9 is a diagram illustrating a configuration of the reservation DB 900 stored in the storage unit 503 of the vehicle management apparatus 500. The reservation DB 900 is a database (DB) for managing renting reservation of the vehicle 300. The reservation DB 900 includes a “reservation user ID”, a “fellow passenger user ID”, a “scheduled renting time”, a “renting parking lot ID”, a “scheduled returning time”, and a “returning parking lot ID”. The user ID of the user who made the reservation is registered in the reservation user ID. As the fellow passenger user ID, a user ID of a user scheduled to ride on the vehicle 300 which the user indicated by the reservation user ID rents is registered. In a case where there is no user scheduled to ride together, the “fellow passenger user ID” is blank. The parking lot ID of the parking lot scheduled by the user as the renting place of the vehicle 300 is registered in the renting parking lot ID. In the returning parking lot ID, a parking lot ID of a parking lot scheduled by the user as a return place of the vehicle 300 is registered.

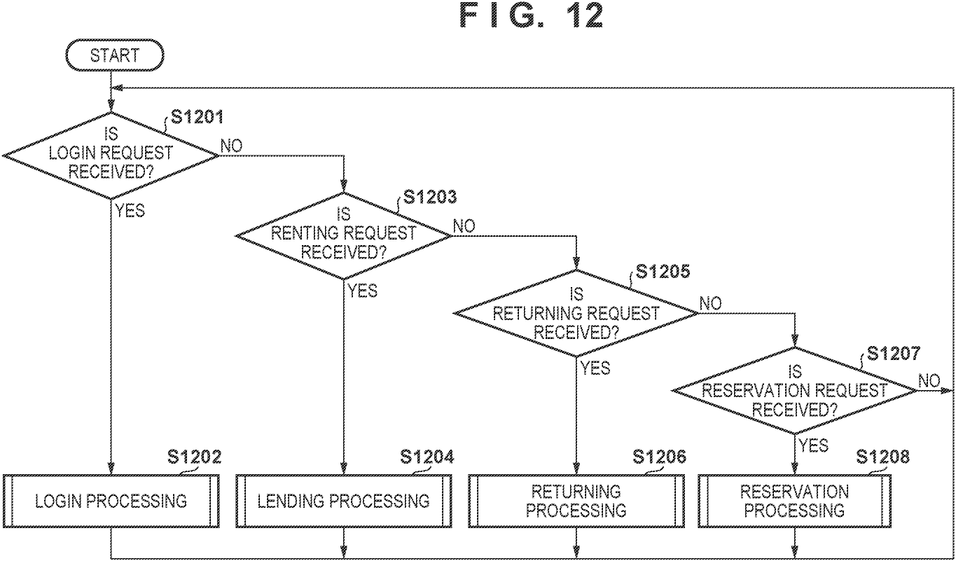

Next, an operation performed by the user of the user terminal 600 will be described with reference to FIGS. 10 and 11. The user can install an application program (hereinafter referred to as “vehicle application”) for performing a renting procedure of the vehicle 300 and the like on the user terminal 600. The installed vehicle application is stored in a storage unit 603 of the user terminal 600.

When the vehicle application is activated, a screen 1001 illustrated in FIG. 10 is displayed on a display unit 604 of the user terminal 600. The user inputs a user ID and a password, and presses a “login” button. As a result, a login request including the user ID and the password is transmitted to the vehicle management apparatus 500. The login processing executed by the vehicle management apparatus 500 in response to the login request will be described later with reference to FIG. 13.

When the login is completed, a screen 1002 is displayed. On the screen 1002, the user can select whether to rent the vehicle 300 without reservation, to rent the vehicle 300 in accordance with a reservation, or to make a reservation for renting the vehicle 300.

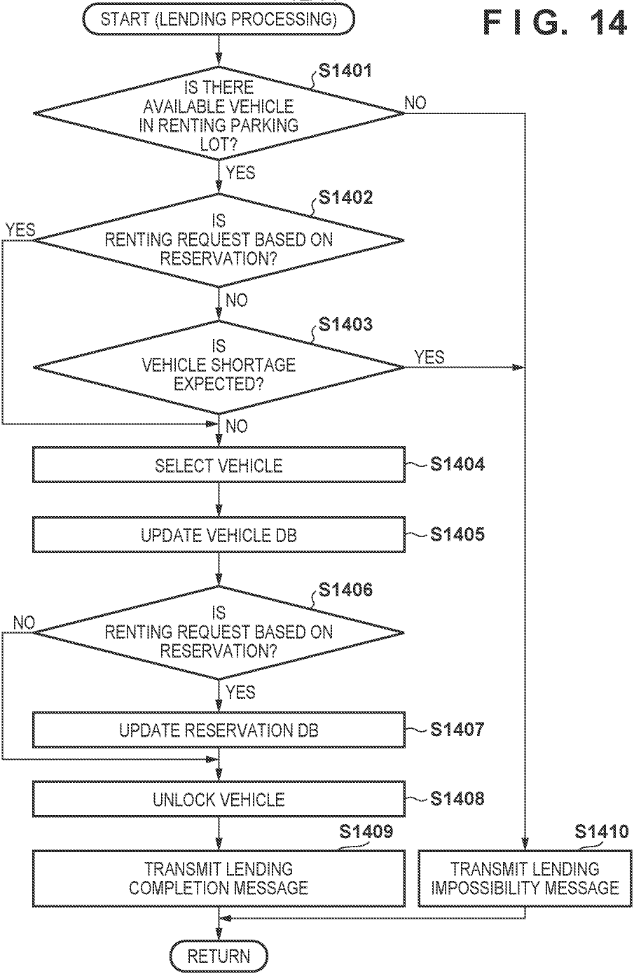

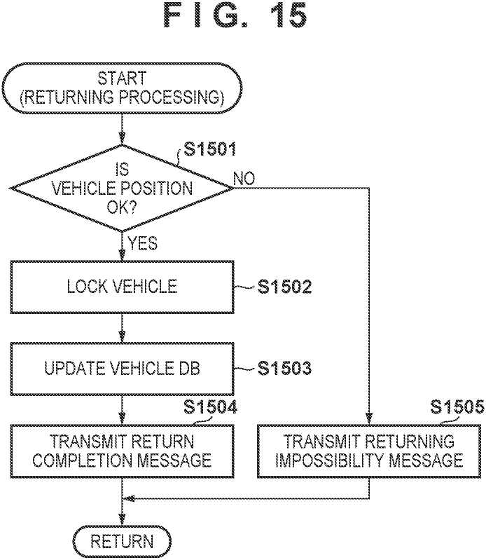

In the case of renting the vehicle 300 without reservation, the user presses a “ride immediately (no reservation)” button on the screen 1002. As a result, a screen 1003 is displayed. The user ID of the logged-in user is displayed on the screen 1003. The user selects a renting parking lot, a returning parking lot, and a scheduled returning time on the screen 1003, and presses an “OK” button. As a result, a renting request including the user ID, the renting parking lot ID, the returning parking lot ID, and the scheduled returning time is transmitted to the vehicle management apparatus 500. The lending processing executed by the vehicle management apparatus 500 in response to the renting request will be described later with reference to FIG. 14. Note that the control unit 601 of the user terminal 600 may automatically select the renting parking lot on the screen 1003 on the basis of position information acquired by a global positioning system (GPS). Furthermore, the control unit 601 may determine whether or not the user is in the selected renting parking lot on the basis of the position information acquired by the GPS, and in a case where the user is not in the selected renting parking lot, may display an error message indicating that the vehicle 300 cannot be lent.

In the case of renting the vehicle 300 in accordance with the reservation, the user presses a “ride immediately (with reservation)” button on the screen 1002. As a result, a screen 1004 is displayed. The screen 1004 displays the user ID of the user who has logged in, and the renting parking lot, the scheduled renting time, the returning parking lot, and the scheduled returning time selected at the time of reservation. In order to display the screen 1004, the control unit 601 acquires, from the storage unit 603, data indicating the renting parking lot, the scheduled renting time, the returning parking lot, and the scheduled returning time selected at the time of reservation. When the user presses the “OK” button, a renting request including the user ID, the renting parking lot ID, the scheduled renting time, the returning parking lot ID, and the scheduled returning time is transmitted to the vehicle management apparatus 500. The lending processing executed by the vehicle management apparatus 500 in response to the renting request will be described later with reference to FIG. 14. Note that the control unit 601 may determine whether or not the user is in the renting parking lot selected at the time of reservation on the basis of the position information acquired by the GPS, and in a case where the user is not in the selected renting parking lot, may display an error message indicating that the vehicle 300 cannot be lent.

When the lending process by the vehicle management apparatus 500 is completed, a screen 1101 illustrated in FIG. 11 is displayed on the display unit 604 of the user terminal 600. On the screen 1101, the user ID of the user who has logged in, the information of the license plate of the lent vehicle 300, the returning parking lot, and the scheduled returning time are displayed. To return the vehicle 300, the user parks the vehicle 300 in the returning parking lot, and presses a “return” button on the screen 1101. As a result, a returning request including the user ID is transmitted to the vehicle management apparatus 500. The returning processing executed by the vehicle management apparatus 500 in response to the returning request will be described later with reference to FIG. 15. When the return of the vehicle 300 is completed, the screen 1002 is displayed again.

To make a renting reservation for the vehicle 300, the user presses a “reserve” button on the screen 1002. As a result, a screen 1102 illustrated in FIG. 11 is displayed on the display unit 604 of the user terminal 600. The user ID of the logged-in user is displayed on the screen 1102. The user selects a renting parking lot, a scheduled renting time, a returning parking lot, and a scheduled returning time, and presses the “OK” button. As a result, a reservation request including the user ID, the renting parking lot ID, the scheduled renting time, the returning parking lot ID, and the scheduled returning time is transmitted to the vehicle management apparatus 500. The reservation processing executed by the vehicle management apparatus 500 in response to the reservation request will be described later with reference to FIG. 16.

When the reservation is successful, a screen 1103 illustrated in FIG. 11 is displayed on the display unit 604 of the user terminal 600. The screen 1103 displays the user ID of the user who has logged in, and the renting parking lot, the scheduled renting time, the returning parking lot, and the scheduled returning time selected at the time of reservation. In addition, the control unit 601 stores, in the storage unit 603, data indicating the renting parking lot, the scheduled renting time, the returning parking lot, and the scheduled returning time selected at the time of reservation. When the user presses the “OK” button on the screen 1103, the screen 1002 is displayed again.

In a case where the reservation fails due to vehicle shortage, a screen 1104 illustrated in FIG. 11 is displayed on the display unit 604 of the user terminal 600. On the screen 1104, the user can select whether to request to secure the vehicle for a successful reservation or to give up the reservation. On the screen 1104, an additional cost required in a case of requesting to secure the vehicle is displayed.

In a case of giving up the reservation, the user presses an “OK” button on the screen 1104. As a result, the screen 1002 is displayed again.

In a case where of requesting to secure of the vehicle, the user presses a “request to secure vehicle” button on the screen 1104. As a result, the vehicle securing request is transmitted to the vehicle management apparatus 500. The processing executed by the vehicle management apparatus 500 in response to the vehicle securing request is included in the reservation processing, and details thereof will be described later with reference to FIG. 16. When the securing of the vehicle is successful, the reservation is successful, and the screen 1103 is displayed. When the securing of the vehicle has failed, a message indicating that the securing of the vehicle has failed is displayed, and then the screen 1002 is displayed again.

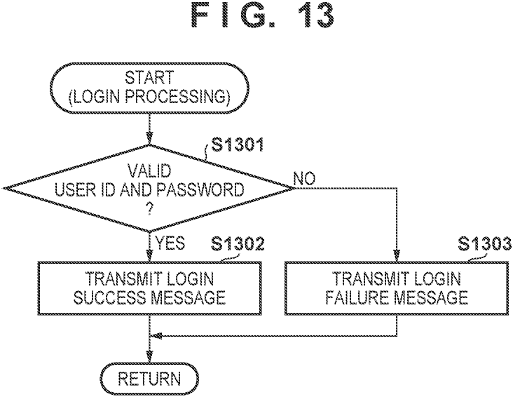

FIG. 12 is a flowchart of processing executed by the vehicle management apparatus 500. In the following description, unless otherwise specified, the control unit 501 of the vehicle management apparatus 500 executes a program to execute the processing of each step of this flowchart (including the flowcharts of FIGS. 13 to 16 that are subroutines).

In step S1201, the control unit 501 determines whether a login request has been received from the user terminal 600. When the login request is received, the processing step proceeds to step S1202, and otherwise, the processing step proceeds to step S1203.

In step S1202, the control unit 501 executes login processing. Details of the login processing will be described later with reference to FIG. 13.

In step S1203, the control unit 501 determines whether or not a renting request has been received from the user terminal 600. When the renting request is received, the processing step proceeds to step S1204, and otherwise, the processing step proceeds to step S1205.

In step S1204, the control unit 501 executes lending processing. Details of the lending processing will be described later with reference to FIG. 14.

In step S1205, the control unit 501 determines whether or not a returning request has been received from the user terminal 600. When the returning request is received, the processing step proceeds to step S1206, and otherwise, the processing step proceeds to step S1207.

In step S1206, the control unit 501 executes returning processing. Details of the returning processing will be described later with reference to FIG. 15.

In step S1207, the control unit 501 determines whether a reservation request has been received from the user terminal 600. When the reservation request is received, the processing step proceeds to step S1208, and otherwise, the processing step returns to step S1201.

In step S1208, the control unit 501 executes reservation processing. Details of the reservation processing will be described later with reference to FIG. 16.

FIG. 13 is a flowchart illustrating details of the login processing (step S1202 of FIG. 12). In step S1301, the control unit 501 refers to the user DB 700 stored in the storage unit 503 to determine whether or not the user ID and the password included in the login request are valid. When the user ID and the password are valid (when an entry in which a combination of the user ID and the password included in the login request is registered exists in the user DB 700), the processing step proceeds to step S1302, and otherwise, the processing step proceeds to step S1303.

In step S1302, the control unit 501 transmits a login success message to the user terminal 600. The login success message includes a token indicating that the user terminal 600 has logged in. Thereafter, when the user terminal 600 accesses the vehicle management apparatus 500, the user terminal 600 transmits the token to the vehicle management apparatus 500, thereby indicating that the user terminal 600 has logged in (the user of the user terminal 600 has been identified and authenticated).

Note that the renting request, returning request, and reservation request described with reference to FIG. 12 are assumed to be transmitted by the logged-in user terminal 600. In a case where a renting request, a returning request, or a reservation request is received from the user terminal 600 that is not logged in, the control unit 501 transmits an error message prompting login to the user terminal 600.

In step S1303, the control unit 501 transmits a login failure message indicating a failure of login to the user terminal 600.

FIG. 14 is a flowchart illustrating details of the lending processing (step S1204 of FIG. 12). In step S1401, the control unit 501 determines whether or not there is an available vehicle (a vehicle that is not currently lent) in the renting parking lot on the basis of the renting parking lot ID included in the renting request and a column of a “parking lot ID” in the vehicle DB 800. If there is an available vehicle, the processing step proceeds to step S1402, and otherwise, the processing step proceeds to step S1410.

In step S1402, the control unit 501 determines whether or not the renting request is based on reservation. In a case where the scheduled renting time is included in the renting request, the control unit 501 determines that the renting request is based on reservation. Note that, even in a case where the renting request includes the scheduled renting time, in a case where the current time is earlier than the scheduled renting time, the control unit 501 may determine that the renting request is not based on reservation. In the case where the renting request is based on reservation, the processing step proceeds to step S1404, and otherwise, the processing step proceeds to step S1403.

In step S1403, the control unit 501 determines whether or not a shortage of vehicles is expected when the vehicle is lent. When the vehicle shortage is expected, the processing step proceeds to step S1410, and otherwise, the processing step proceeds to step S1404.

An example of a criterion for determining whether vehicle shortage is expected will be described. First, the control unit 501 determines the number of available vehicles in the renting parking lot on the basis of the renting parking lot ID included in the renting request and the column of the “parking lot ID” in the vehicle DB 800. Next, the control unit 501 determines a time-series change in the number of available vehicles in the renting parking lot on the basis of the columns of the “scheduled returning time” and the “returning parking lot ID” in the vehicle DB 800 and the columns of the “scheduled renting time”, the “renting parking lot ID”, the “scheduled returning time”, and the “returning parking lot ID” in the reservation DB 900. In a case where the reservation DB 900 includes an entry (renting reservation) in which the same renting parking lot ID as the renting parking lot ID included in the renting request is registered, it is determined that the number of available vehicles decreases by one at the scheduled renting time corresponding to the entry. Similarly, when the reservation DB 900 includes an entry in which the same returning parking lot ID as the renting parking lot ID included in the renting request is registered, it is determined that the number of available vehicles increases by one at the scheduled returning time corresponding to the entry. Furthermore, when the vehicle DB 800 includes an entry in which the same returning parking lot ID as the renting parking lot ID included in the renting request is registered, it is determined that the number of available vehicles increases by one at the scheduled returning time corresponding to the entry. Then, the control unit 501 determines whether or not there is a timing at which the number of available vehicles becomes 0 between the current time and the scheduled returning time included in the renting request. In a case where there is a timing at which the number of available vehicles becomes 0, the control unit 501 determines that a shortage of vehicles is expected. Note that, in a case where the renting parking lot ID and the returning parking lot ID included in the renting request do not match each other, the control unit 501 may determine whether or not there is a timing at which the number of available vehicles becomes 0, including a time period after the scheduled returning time (for example, from the current time to three hours after the scheduled returning time).

In step S1404, the control unit 501 selects a vehicle to be lent. The selection criterion is not particularly limited, but as an example, the control unit 501 selects a vehicle having the largest charge amount among vehicles parked at a position where the vehicle can exit the parking lot.

In step S1405, the control unit 501 updates the vehicle DB 800. Specifically, the control unit 501 changes the “parking lot ID” in the entry of the vehicle DB 800 corresponding to the vehicle to be lent to blank. Furthermore, the control unit 501 registers the user ID, the scheduled returning time, and the returning parking lot ID included in the renting request in each of the “user ID”, the “scheduled returning time”, and the “returning parking lot ID” of this entry.

In step S1406, similarly to step S1402, the control unit 501 determines whether or not the renting request is based on reservation. If the renting request is based on reservation, the processing step proceeds to step S1407, and otherwise, the processing step proceeds to step S1408.

In step S1407, the control unit 501 updates the reservation DB 900. Specifically, the control unit 501 deletes the entry corresponding to the renting request from the reservation DB 900. Note that the identification of the entry corresponding to the renting request can be performed on the basis of the user ID, the scheduled renting time, and the like included in the renting request.

In step S1408, the control unit 501 unlocks the vehicle to be lent. The release of the lock is performed, for example, by the control unit 501 instructing the control unit 301 of the vehicle 300 to release the lock via the communication network. When the vehicle 300 is unlocked, the user can get on and drive the vehicle 300.

In step S1409, the control unit 501 transmits a lending completion message including information of the license plate of the vehicle to be lent to the user terminal 600. The user terminal 600 can display a screen such as a screen 1101 of FIG. 11 on the basis of the lending completion message.

In step S1410, the control unit 501 transmits, to the user terminal 600, a lending impossibility message indicating that the vehicle cannot be lent.

FIG. 15 is a flowchart illustrating details of the returning processing (step S1206 of FIG. 12). In step S1501, the control unit 501 determines whether or not the vehicle 300 is parked at a correct position. The parking position of the vehicle 300 can be identified by using, for example, a sensor installed in the parking lot 200. In a case where the vehicle 300 is parked at an appropriate position in the parking lot 200 and the parking lot 200 coincides with the returning parking lot, the control unit 501 determines that the vehicle 300 is parked at the correct position. The returning parking lot can be identified by referring to the returning parking lot ID corresponding to the user ID included in the returning request in the vehicle DB 800. In a case where the vehicle 300 is parked at the correct position, the processing step proceeds to step S1502, and otherwise, the processing step proceeds to step S1505.

In step S1502, the control unit 501 locks the vehicle 300. The vehicle is locked, for example, by the control unit 501 instructing the control unit 301 of the vehicle 300 to lock via the communication network.

In step S1503, the control unit 501 updates the vehicle DB 800. Specifically, the control unit 501 registers the returning parking lot ID in the “parking lot ID” of the entry of the vehicle DB 800 corresponding to the returned vehicle. In addition, the control unit 501 changes the “user ID”, the “scheduled returning time”, and the “returning parking lot ID” of this entry to blanks.

In step S1504, the control unit 501 transmits a return completion message indicating that the return of the vehicle is completed to the user terminal 600.

In step S1505, the control unit 501 transmits a returning impossibility message indicating that the vehicle cannot be returned to the user terminal 600.

FIG. 16 is a flowchart illustrating details of the reservation processing (step S1208 of FIG. 12). First, by the processing of steps S1601 and S1602, the control unit 501 determines whether or not the vehicle 300 can be lent at the scheduled renting time included in the reservation request in the parking lot 200 indicated by the renting parking lot ID included in the reservation request.

Specifically, in step S1601, the control unit 501 refers to the scheduled renting time and the renting parking lot ID included in the reservation request, and determines whether or not there is an available vehicle in the renting parking lot at the scheduled renting time. In order to make this determination, for example, the control unit 501 determines a time-series change in the number of available vehicles in the renting parking lot, similarly to step S1404 of FIG. 14. Then, if the number of available vehicles at the scheduled renting time is 1 or more, the control unit 501 determines that there is an available vehicle in the renting parking lot at the scheduled renting time. In a case where there is an available vehicle in the renting parking lot at the scheduled renting time, the processing step proceeds to step S1602, and otherwise, the processing step proceeds to step S1605.

In step S1602, the control unit 501 determines whether a shortage of vehicles is expected. The determination in step S1602 can be performed similarly to the determination in step S1403. However, although the period from the current time to the scheduled returning time included in the renting request is the determination target period in step S1403, in step S1602, the period from the scheduled renting time to the scheduled returning time included in the reservation request is the determination target period. Similarly to step S1403, when the renting parking lot ID and the returning parking lot ID included in the reservation request do not match, the control unit 501 may also include a time period after the scheduled returning time in the determination target period. When the vehicle shortage is expected, the processing step proceeds to step S1605, and otherwise, the processing step proceeds to step S1603.

In step S1603, the control unit 501 updates the reservation DB 900. Specifically, the control unit 501 adds, to the reservation DB 900, an entry in which the user ID, the scheduled renting time, the renting parking lot ID, the scheduled returning time, and the returning parking lot ID included in the reservation request are registered (the user ID is registered in the column of “reservation user ID”).

In step S1604, the control unit 501 transmits a reservation completion message indicating that the reservation is completed to the user terminal 600. As a result, a screen such as a screen 1103 in FIG. 11 is displayed on the display unit 604 of the user terminal 600.

In step S1605, the control unit 501 transmits, to the user terminal 600, a reservation impossibility message indicating that the reservation cannot be made due to the vehicle shortage. As a result, a screen such as a screen 1104 in FIG. 11 is displayed on the display unit 604 of the user terminal 600.

In step S1605, the control unit 501 determines whether a vehicle securing request has been received from the user terminal 600. The vehicle securing request is transmitted from the user terminal 600 to the vehicle management apparatus 500 when the user presses a “request to secure vehicle” button on the screen 1104. In a case where the vehicle securing request is received, the processing step proceeds to step S1607, and otherwise, the reservation processing of this flowchart is finished.

In step S1607, the control unit 501 transmits, to the user terminal 600 of another user, a notification for inviting delivery or ride-sharing of a vehicle in a form of increasing the number of available vehicles in the time period corresponding to the reservation request. Although a specific form of the invitation is not particularly limited, for example, the control unit 501 can invite users who deliver vehicles from a parking lot (for example, the parking lot 200b) different from the renting parking lot (for example, the parking lot 200a) to the renting parking lot by the scheduled renting time. As another example, the control unit 501 invites users who share their rides in a form of canceling the renting reservation conflicting with the reservation request. In order to perform this invitation, the control unit 501 refers to the reservation DB 900 and searches for a renting reservation (for example, a renting reservation for renting a vehicle from the renting parking lot included in the reservation request in a time period corresponding to the reservation request) conflicting with the reservation request. In a case where a plurality of renting reservations conflicting with the reservation request are found, the control unit 501 invite ride-sharing from users corresponding to the plurality of found renting reservations.

In step S1608, the control unit 501 determines whether or not there has been an application in response to the invitation for vehicle delivery or ride-sharing from another user. In a case where there has been the application, the processing step proceeds to step S 1609, and in a case where there has been no application, the processing step proceeds to step S1610.

In step S1609, the control unit 501 updates the reservation DB 900. The update of the reservation DB 900 in step S1609 includes an update regarding the user who has requested to secure the vehicle and an update regarding the user who has applied in response to the invitation for the vehicle delivery or ride-sharing. The update related to the user who has requested to secure the vehicle is similar to step S1603.

In a case where there is an application in response to the invitation for the vehicle delivery, the control unit 501 adds an entry including the user ID of the user who applied as the “reservation user ID” to the reservation DB 900. The parking lot ID of the parking lot selected by the control unit 501 at the time of invitation and the parking lot to be lent included in the reservation request are registered in the “renting parking lot” and the “returning parking lot” of this entry, respectively. In the “scheduled renting time” and the “scheduled returning time” of this entry, the time selected by the user who applied is registered under the condition that the vehicle is returned by the scheduled renting time included in the reservation request.

In a case where there is an application for ride-sharing, the control unit 501 deletes the entry of the user who has accepted to ride on the vehicle of another user in the reservation DB 900, and registers the user ID of this user in the “fellow passenger user ID” of the entry of the user who has accepted to ride on the vehicle of another user.

Note that the control unit 501 may give a reward to a user who has applied for the invitation for vehicle delivery or ride-sharing. The reward is not particularly limited, but is, for example, a coupon, and in this case, the control unit 501 can transmit an electronic coupon to the user terminal 600 of the user who has applied.

In step S1610, the control unit 501 transmits a securing failure message indicating that the securing of the vehicle has failed to the user terminal 600 of the user who has requested to secure of the vehicle.

### Summary of Embodiments

The foregoing embodiments disclose at least the following vehicle management system, vehicle management method, and storage medium.

### Item 1

A vehicle management system comprising at least one processor and/or at least one circuit which functions as:
a storage unit configured to store user information for identifying a plurality of users that are employees of a corporation, and vehicle information including a lending status of a plurality of vehicles that travel by electric power;
an identification unit configured to identify a first user included in the plurality of users on a basis of the user information;
a first receiving unit configured to receive a renting request from the first user; and
a lending unit configured to execute lending processing of lending a first vehicle among the plurality of vehicles to the first user in accordance with the reception of the renting request, wherein the lending processing includes:
   processing of selecting, from the plurality of vehicles, the first vehicle that is not selected before the reception of the renting request on a basis of the lending status; and
   processing of updating the lending status so as to reflect the lending of the first vehicle.

According to this embodiment, the vehicle to be lent to the user (employee of the corporation) is not selected before the reception of the renting request, and is selected on the basis of the lending status in response to the reception of the renting request. Therefore, since it is not necessary to allocate a unique vehicle for each user in advance, corporate employees can efficiently share a plurality of vehicles traveling by electric power.

### Item 2

The vehicle management system according to item 1, wherein the at least one processor and/or the at least one circuit further functions as:
an acquisition unit configured to acquire prediction of power demand in a facility of the corporation; and
a determination unit configured to determine a charging schedule of a vehicle connected to a charging unit included in the facility of the corporation on a basis of the prediction of the power demand.

According to this embodiment, since the power consumption amount in the corporate facility can be adjusted, for example, a peak cut or a peak shift of the power consumption amount can be realized.

### Item 3

The vehicle management system according to item 2,
wherein the acquisition unit acquires prediction of a power generation amount of a photovoltaic power generation unit included in the facility of the corporation, and
the determination unit determines the charging scheduled further on a basis of the prediction of the power generation amount.

According to this embodiment, since the power generation amount of a photovoltaic power generation unit is taken into consideration, it is possible to more effectively adjust the power consumption amount in the facility of the corporation.

### Item 4

The vehicle management system according to item 2,

wherein the vehicle information includes the charging schedule, a connection status of the plurality of vehicles to the charging unit, and a charging amount of the plurality of vehicles.

According to this embodiment, it is possible to manage the charging schedule related to the adjustment of the power consumption amount in the corporate facility, the connection status of the plurality of vehicles to the charging units, and the charging amount of the plurality of vehicles as the vehicle information.

### Item 5

The vehicle management system according to item 1, wherein the at least one processor and/or the at least one circuit further functions as:
an acquisition unit configured to acquire prediction of power demand in a facility of the corporation;
a control unit configured to perform control such that power charged in a vehicle connected to a charging unit included in the facility of the corporation is supplied to a load included in the facility of the corporation; and
a planning unit configured to plan delivery of a vehicle from outside of the facility of the corporation to inside of the facility of the corporation on a basis of the prediction of the power demand.

According to this embodiment, it is possible to increase the amount of power that can be supplied to the load included in the corporate facility according to the prediction of the power demand.

### Item 6

The vehicle management system according to item 1, further comprising

a parking lot in which highly densely parking of at least part of the plurality of vehicles is possible.

According to this embodiment, it is possible to reduce the area of a parking lot required per vehicle.

### Item 7

The vehicle management system according to item 1, wherein the at least one processor and/or the at least one circuit further functions as:
a second receiving unit configured to receive a returning request from the first user while the first vehicle is lent; and
a returning unit configured to execute returning processing of the first vehicle in accordance with the reception of the returning request, wherein the returning processing includes
   processing of updating the lending status so as to reflect return of the first vehicle.

According to this embodiment, a user who has rented a vehicle can return the vehicle.

### Item 8

The vehicle management system according to item 1,
wherein the storage unit stores reservation information including one or more renting reservations each including identification information of a user and a scheduled renting time, and
the at least one processor and/or the at least one circuit further functions as:
   a third receiving unit configured to receive a reservation request including a first scheduled renting time from the first user; and
   a reservation unit configured to execute reservation processing in accordance with the reception of the reservation request, wherein the reservation processing includes:
      processing of determining whether or not it is possible to lend a vehicle at the first scheduled renting time on a basis of the lending status and the reservation information; and
      processing of adding a renting reservation including identification information of the first user and the first scheduled renting time to the reservation information in a case where it has been determined that it is possible to lend a vehicle at the first scheduled renting time.

According to this embodiment, it is possible for a user to reserve a vehicle for renting.

### Item 9

The vehicle management system according to item 8, wherein the reservation processing further includes:
processing of, in a case where it has been determined that it is not possible to lend a vehicle at the first scheduled renting time, inviting a user who performs ride-sharing in a form of canceling a renting reservation conflicting with the reservation request among the one or more renting reservations; and
processing of, in a case where there is an application in response to the invitation for the user who performs ride-sharing, cancelling the renting reservation conflicting with the reservation request and adding a renting reservation including the identification information of the first user and the first scheduled renting time to the reservation information.

According to this embodiment, even in a case where there are not enough vehicles, the user can make a reservation.

### Item 10

The vehicle management system according to item 1,
wherein the lending status includes identification information of a parking lot of a vehicle that is parked without being lent,
the storage unit stores reservation information includes one or more renting reservations each including identification information of a user, identification information of a parking lot where renting is to be performed, and scheduled renting time, and
the at least one processor and/or the at least one circuit further functions as:
   a third receiving unit configured to receive a reservation request including identification information of a first parking lot where renting is to be performed and a first scheduled renting time from the first user; and
   a reservation unit configured to execute reservation processing in accordance with the reception of the reservation request, wherein the reservation processing includes:
      processing of determining whether or not it is possible to lend a vehicle in the first parking lot at the first scheduled renting time on a basis of the lending status and the reservation information; and
      processing of adding a renting reservation including identification information of the first user, the identification information of the first parking lot, and the first scheduled renting time to the reservation information in a case where it has been determined that it is possible to lend a vehicle in the first parking lot at the first scheduled renting time.

According to this embodiment, it is possible for a user to reserve a vehicle for renting.

### Item 11

The vehicle management system according to item 10, wherein the reservation processing further includes:
processing of, in a case where it has been determined that it is not possible to lend a vehicle in the first parking lot at the first scheduled renting time, inviting a user who delivers a vehicle from a parking lot different from the first parking lot to the first parking lot by the first scheduled renting time; and
processing of, in a case where there is an application in response to the invitation for the user who delivers a vehicle, adding a renting reservation including the identification information of the first user, the identification information of the first parking lot, and the first scheduled renting time to the reservation information.

According to this embodiment, even in a case where there are not enough vehicles, the user can make a reservation.

### Item 12

A vehicle management method executed by a vehicle management system comprising a memory configured to store user information for identifying a plurality of users that are employees of a corporation, and vehicle information including a lending status of a plurality of vehicles that travel by electric power, the method comprising:
identifying a first user included in the plurality of users on a basis of the user information;
receiving a renting request from the first user; and
executing lending processing of lending a first vehicle among the plurality of vehicles to the first user in accordance with the reception of the renting request, wherein the lending processing includes:
   processing of selecting, from the plurality of vehicles, the first vehicle that is not selected before the reception of the renting request on a basis of the lending status; and
   processing of updating the lending status so as to reflect the lending of the first vehicle.

According to this embodiment, the vehicle to be lent to the user (employee of the corporation) is not selected before the reception of the renting request, and is selected on the basis of the lending status in response to the reception of the renting request. Therefore, since it is not necessary to allocate a unique vehicle for each user in advance, corporate employees can efficiently share a plurality of vehicles traveling by electric power.

### Item 13

A non-transitory computer-readable storage medium which stores a program for causing a computer, which comprises a memory configured to store user information for identifying a plurality of users that are employees of a corporation, and vehicle information including a lending status of a plurality of vehicles that travel by electric power, to execute a vehicle management method comprising:
identifying a first user included in the plurality of users on a basis of the user information;
receiving a renting request from the first user; and
executing lending processing of lending a first vehicle among the plurality of vehicles to the first user in accordance with the reception of the renting request, wherein the lending processing includes:
   processing of selecting, from the plurality of vehicles, the first vehicle that is not selected before the reception of the renting request on a basis of the lending status; and
   processing of updating the lending status so as to reflect the lending of the first vehicle.

According to this embodiment, the vehicle to be lent to the user (employee of the corporation) is not selected before the reception of the renting request, and is selected on the basis of the lending status in response to the reception of the renting request. Therefore, since it is not necessary to allocate a unique vehicle for each user in advance, corporate employees can efficiently share a plurality of vehicles traveling by electric power.

Note that no particular limitation is intended with regard to the specific configurations of software and hardware for implementing various types of functions that have been described in the foregoing embodiments. Arbitrary software, arbitrary hardware, and an arbitrary combination of arbitrary software and arbitrary hardware are encompassed within the scope of the foregoing embodiments, as long as they are technically possible.

The invention is not limited to the foregoing embodiments, and various variations/changes are possible within the spirit of the invention.

What is claimed is:

1. A vehicle management system comprising at least one processor and/or at least one circuit which functions as:
a storage unit configured to store user information for identifying a plurality of users that are employees of a corporation, and vehicle information including a lending status of a plurality of vehicles that travel by electric power;
an identification unit configured to identify a first user included in the plurality of users on a basis of the user information;
a first receiving unit configured to receive a renting request from the first user; and
a lending unit configured to execute lending processing of lending a first vehicle among the plurality of vehicles to the first user in accordance with the reception of the renting request, wherein the lending processing includes:
processing of selecting, from the plurality of vehicles, the first vehicle that is not selected before the reception of the renting request on a basis of the lending status; and
processing of updating the lending status so as to reflect the lending of the first vehicle.

2. The vehicle management system according to claim 1, wherein the at least one processor and/or the at least one circuit further functions as:
an acquisition unit configured to acquire prediction of power demand in a facility of the corporation; and
a determination unit configured to determine a charging schedule of a vehicle connected to a charging unit included in the facility of the corporation on a basis of the prediction of the power demand.

3. The vehicle management system according to claim 2,
wherein the acquisition unit acquires prediction of a power generation amount of a photovoltaic power generation unit included in the facility of the corporation, and
the determination unit determines the charging scheduled further on a basis of the prediction of the power generation amount.

4. The vehicle management system according to claim 2,
wherein the vehicle information includes the charging schedule, a connection status of the plurality of vehicles to the charging unit, and a charging amount of the plurality of vehicles.

5. The vehicle management system according to claim 1, wherein the at least one processor and/or the at least one circuit further functions as:
an acquisition unit configured to acquire prediction of power demand in a facility of the corporation;
a control unit configured to perform control such that power charged in a vehicle connected to a charging unit included in the facility of the corporation is supplied to a load included in the facility of the corporation; and
a planning unit configured to plan delivery of a vehicle from outside of the facility of the corporation to inside of the facility of the corporation on a basis of the prediction of the power demand.

6. The vehicle management system according to claim 1, further comprising
a parking lot in which highly densely parking of at least part of the plurality of vehicles is possible.

7. The vehicle management system according to claim 1, wherein the at least one processor and/or the at least one circuit further functions as:
a second receiving unit configured to receive a returning request from the first user while the first vehicle is lent; and
a returning unit configured to execute returning processing of the first vehicle in accordance with the reception of the returning request, wherein the returning processing includes
processing of updating the lending status so as to reflect return of the first vehicle.

8. The vehicle management system according to claim 1,
wherein the storage unit stores reservation information including one or more renting reservations each including identification information of a user and a scheduled renting time, and
the at least one processor and/or the at least one circuit further functions as:
a third receiving unit configured to receive a reservation request including a first scheduled renting time from the first user; and
a reservation unit configured to execute reservation processing in accordance with the reception of the reservation request, wherein the reservation processing includes:
processing of determining whether or not it is possible to lend a vehicle at the first scheduled renting time on a basis of the lending status and the reservation information; and
processing of adding a renting reservation including identification information of the first user and the first scheduled renting time to the reservation information in a case where it has been determined that it is possible to lend a vehicle at the first scheduled renting time.

9. The vehicle management system according to claim 8, wherein the reservation processing further includes:
processing of, in a case where it has been determined that it is not possible to lend a vehicle at the first scheduled renting time, inviting a user who performs ride-sharing in a form of canceling a renting reservation conflicting with the reservation request among the one or more renting reservations; and
processing of, in a case where there is an application in response to the invitation for the user who performs ride-sharing, cancelling the renting reservation conflicting with the reservation request and adding a renting reservation including the identification information of the first user and the first scheduled renting time to the reservation information.

10. The vehicle management system according to claim 1,
wherein the lending status includes identification information of a parking lot of a vehicle that is parked without being lent,
the storage unit stores reservation information includes one or more renting reservations each including identification information of a user, identification information of a parking lot where renting is to be performed, and scheduled renting time, and
the at least one processor and/or the at least one circuit further functions as:
a third receiving unit configured to receive a reservation request including identification information of a first parking lot where renting is to be performed and a first scheduled renting time from the first user; and
a reservation unit configured to execute reservation processing in accordance with the reception of the reservation request, wherein the reservation processing includes:
processing of determining whether or not it is possible to lend a vehicle in the first parking lot at the first scheduled renting time on a basis of the lending status and the reservation information; and
processing of adding a renting reservation including identification information of the first user, the identification information of the first parking lot, and the first scheduled renting time to the reservation information in a case where it has been determined that it is possible to lend a vehicle in the first parking lot at the first scheduled renting time.

11. The vehicle management system according to claim 10, wherein the reservation processing further includes:
processing of, in a case where it has been determined that it is not possible to lend a vehicle in the first parking lot at the first scheduled renting time, inviting a user who delivers a vehicle from a parking lot different from the first parking lot to the first parking lot by the first scheduled renting time; and
processing of, in a case where there is an application in response to the invitation for the user who delivers a vehicle, adding a renting reservation including the identification information of the first user, the identification information of the first parking lot, and the first scheduled renting time to the reservation information.

12. A vehicle management method executed by a vehicle management system comprising a memory configured to store user information for identifying a plurality of users that are employees of a corporation, and vehicle information including a lending status of a plurality of vehicles that travel by electric power, the method comprising:
identifying a first user included in the plurality of users on a basis of the user information;
receiving a renting request from the first user; and
executing lending processing of lending a first vehicle among the plurality of vehicles to the first user in accordance with the reception of the renting request, wherein the lending processing includes:
processing of selecting, from the plurality of vehicles, the first vehicle that is not selected before the reception of the renting request on a basis of the lending status; and
processing of updating the lending status so as to reflect the lending of the first vehicle.

13. A non-transitory computer-readable storage medium which stores a program for causing a computer, which comprises a memory configured to store user information for identifying a plurality of users that are employees of a corporation, and vehicle information including a lending status of a plurality of vehicles that travel by electric power, to execute a vehicle management method comprising:
identifying a first user included in the plurality of users on a basis of the user information;
receiving a renting request from the first user; and
executing lending processing of lending a first vehicle among the plurality of vehicles to the first user in accordance with the reception of the renting request, wherein the lending processing includes:
processing of selecting, from the plurality of vehicles, the first vehicle that is not selected before the reception of the renting request on a basis of the lending status; and
processing of updating the lending status so as to reflect the lending of the first vehicle.
